(19) United States
(12) Patent Application Publication
(10) Pub. No.: US 2025/0111023 A1
(43) Pub. Date: Apr. 3, 2025

(54) BIOMETRIC AUTHENTICATION

(71) Applicant: Cypress Semiconductor Corporation, San Jose, CA (US)

(72) Inventors: Igor Kolych, Lviv (UA); Kiran Uln, Pleasanton, CA (US)

(73) Assignee: Cypress Semiconductor Corporation, San Jose, CA (US)

(21) Appl. No.: 18/476,565

(22) Filed: Sep. 28, 2023

(51) Int. Cl. G06F 21/32; H04W 12/06

(52) U.S. Cl. CPC G06F 21/32; H04W 12/06

(57) ABSTRACT

A system includes a portable device and a wireless device. The portable device senses biometric information of a user. The wireless device includes a controller and a radio transceiver. The controller is configured to receive, via the radio transceiver, the biometric information sensed by the portable device and sense, via the wireless device, biometric information of the user corresponding to the biometric information sensed by the portable device. The controller is further configured to compare the biometric information sensed by the portable device to the biometric information sensed by the wireless device to obtain a first comparison result and authenticate the user in response to the first comparison result being less than a first threshold.

### BACKGROUND

Secured access is a popular application being developed in Internet of Things (IoT) technologies. In addition, there are a variety of applications that use biometrical identification (e.g., fingerprint). There are multiple ways to attack secured access systems, such as man-in-the-middle attacks. The success of such attacks depends on the strength of the security of the secured access systems.

For these and other reasons, a need exists for the present invention.

### SUMMARY

Some examples of the present disclosure relate to a system. The system includes a portable device and a wireless device. The portable device senses biometric information of a user. The wireless device includes a controller and a radio transceiver. The controller is configured to receive, via the radio transceiver, the biometric information sensed by the portable device and sense, via the wireless device, biometric information of the user corresponding to the biometric information sensed by the portable device. The controller is further configured to compare the biometric information sensed by the portable device to the biometric information sensed by the wireless device to obtain a first comparison result and authenticate the user in response to the first comparison result being less than a first threshold.

Other examples of the present disclosure relate to a system. The system includes a wireless device including a controller and a radio transceiver. The controller is configured to retrieve stored biometric information of a user and in response to the user approaching the wireless device, sense, via the wireless device, biometric information of the user corresponding to the stored biometric information. The controller is further configured to compare the stored biometric information to the biometric information sensed by the wireless device to obtain a first comparison result and authenticate the user in response to the first comparison result being less than a first threshold.

Yet other examples of the present disclosure relate to a method for authenticating a user. The method includes receiving, at a wireless device, biometric information of the user sensed by a portable device. The method includes sensing, via the wireless device, biometric information of the user corresponding to the biometric information sensed by the portable device. The method includes comparing the biometric information sensed by the portable device to the biometric information sensed by the wireless device to obtain a first comparison result. The method includes authenticating the user in response to the first comparison result being less than a first threshold.

### BRIEF DESCRIPTION OF THE DRAWINGS

FIGS. 1A-1C illustrate example systems for authenticating a user.

FIG. 2 illustrates another example system for authenticating a user.

FIGS. 3A and 3B illustrate another example system for authenticating a user.

FIGS. 4A and 4B are graphs illustrating example criteria for authenticating a user.

FIG. 5 illustrates another example system for authenticating a user.

FIG. 6 illustrates one example method for authenticating a user for a smart lock application.

FIG. 7 illustrates one example method for authenticating a user for a PC screen locker application.

FIG. 8 illustrates one example system for authenticating a user for a smart lock application.

FIGS. 9A-9D are flow diagrams illustrating one example method for authenticating a user.

FIGS. 10A and 10B are flow diagrams illustrating another example method for authenticating a user.

FIGS. 11A and 11B are flow diagrams illustrating another example method for authenticating a user.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

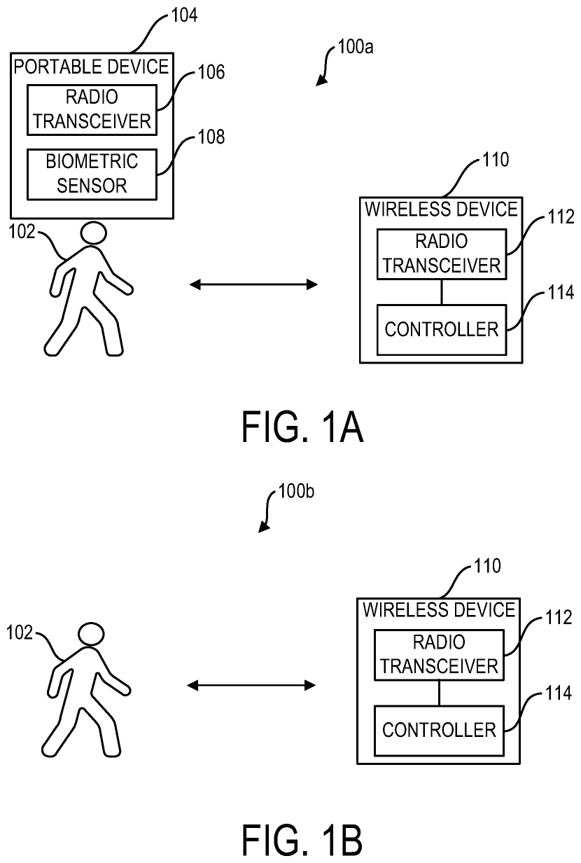

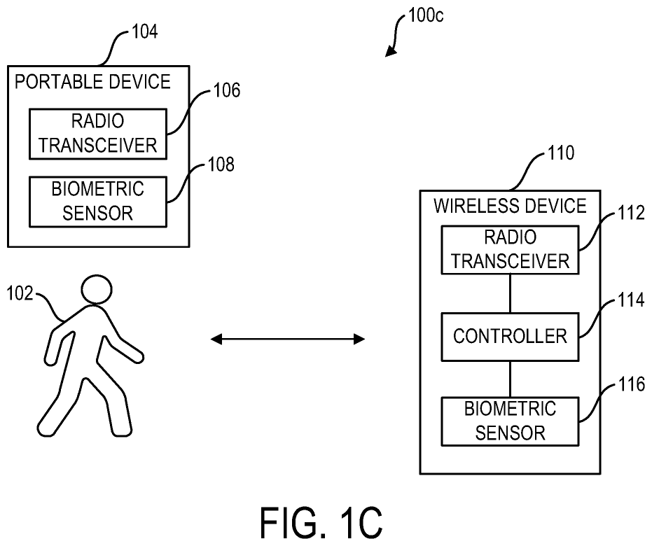

FIG. 1A illustrates an example system 100a for authenticating a user 102. The system 100a includes a portable device 104 and a wireless device 110. The portable device 104 includes a radio transceiver 106 and a biometric sensor 108. The radio transceiver 106 may include a Bluetooth (BT) transceiver, a Bluetooth Low Energy (BLE) transceiver, a Wi-Fi transceiver, an Ultra-wideband (UWB) transceiver, or another suitable transceiver capable of communicating wirelessly with wireless device 110. The biometric sensor 108 is configured to sense biometric information of the user 102. In one example, the biometric sensor 108 is a vital sign sensor and the biometric information sensed is a vital sign (e.g., pulse rate, respiratory rate, temperature, etc.) of the user 102. In some examples, the biometric information of the user 102 includes at least one of respiration rate information, pulse rate information, heart rate information, electrocardiogram information, fingerprint information, or iris information.

The portable device 104 may include a wearable device (e.g., smartwatch, fitness band, etc.), an implantable medical device (e.g., pacemaker, etc.), and/or a device than may be carried by the user 102 (e.g., smartphone, tablet, etc.). In some examples, the user 102 may initiate (e.g., by pressing a button, performing a gesture, speaking a command) the transfer (e.g., via the radio transceiver 106) of the biometric information sensed by the biometric sensor 108 of the portable device 104 to the wireless device 110. In other examples, the biometric information sensed by the biometric sensor 108 of the portable device 104 is automatically transferred to the wireless device 110 via the radio transceiver 106 in response to the user 102 approaching the wireless device 110 (e.g., in response to the user coming within a range between zero feet and 20 feet of the wireless device).

The wireless device 110 includes a radio transceiver 112 and a controller 114. The radio transceiver 112 may include a BT transceiver, a BLE transceiver, a Wi-Fi transceiver, an UWB transceiver, or another suitable transceiver capable of communicating wirelessly with portable device 104. The controller 114 may be a Central Processing Unit (CPU), microprocessor, microcontroller, Application Specific Integrated Circuit (ASIC), or other suitable logic circuitry for controlling the operation of the wireless device 110 including the radio transceiver 112. In some examples, the controller 114 may include a machine-readable storage medium (e.g., read-only memory, non-volatile memory) storing instructions (e.g., firmware and/or software) to be executed by the controller 114 for controlling the operation of the wireless device 110. Wireless device 110 may be part of any suitable secure access system, which implements an authentication procedure of the user 102 prior to granting access to the user, such as a smart lock (e.g., door lock, gate lock), a vehicle (e.g., car, truck), or a computing device (e.g., personal computer (PC)).

In one example to authenticate the user 102, the controller 114 receives, via the radio transceiver 112 from the radio transceiver 106, biometric information sensed by the biometric sensor 108 of the portable device 104. The controller 114 senses, via the wireless device 110, biometric information of the user 102 corresponding to the biometric information sensed by the biometric sensor 108 of the portable device 104. In some examples, the controller 114 senses the biometric information of the user 102 corresponding to the biometric information sensed by the portable device 104 by sensing, via radio frequency (RF) sensing using radio transceiver 112, a vital sign of the user 102 corresponding to a vital sign sensed by a vital sign sensor (of biometric sensor 108) of the portable device 104. The controller 114 then compares the biometric information sensed by the portable device 104 to the biometric information sensed by the wireless device 110 to obtain a first comparison result. The controller authenticates the user 102 in response to the first comparison result being less than a first threshold, which indicates the biometric information sensed by the portable device 104 substantially matches the biometric information sensed by the wireless device 110. The controller 114 fails to authenticate the user 102 (e.g., rejects the user) in response to the first comparison result being greater than the first threshold, which indicates the biometric information sensed by the portable device 104 does not match the biometric information sensed by the wireless device 110.

In some examples, the controller 114 of the wireless device 110 may further determine, via the radio transceiver 112, a location of the portable device 104 relative to the wireless device 110 (e.g., via Angle of Arrival (AoA), phase ranging, Time of Flight (ToF), or other localization method). The controller 114 may also determine, via the radio transceiver 112, a location of the user 102 relative to the wireless device 110. The controller 114 then compares the location of the portable device 104 to the location of the user 102 to obtain a second comparison result. In this example, authenticating the user 102 includes authenticating the user 102 in response to the first comparison result being less than the first threshold and the second comparison result being less than a second threshold, which indicates that the location of the portable device 104 substantially matches the location of the user 102 (e.g., within an arm's length of the user 102). In this way, the security of system 100a is improved since both biometric information measured by the portable device 104 and the wireless device 110 and location information of the portable device 104 and the user 102 is used to authenticate the user 102.

In some examples, the controller 114 may receive, via the radio transceiver 112, an active time (e.g., in use/sensing time, time disconnected from charging device, etc.) of the portable device 104. In this example, authenticating the user 102 includes authenticating the user in response to the first comparison result being less than the first threshold, the second comparison result being less than the second threshold, and the active time being greater than a third threshold, which indicates the portable device 104 has been active for at least a minimum amount of time.

In some examples, the controller 114 stores the biometric information sensed by the portable device 104 such that subsequent to authenticating the user 102, in response to the user 102 departing the wireless device 110, the controller revokes the authentication of the user 102. In response to the user 102 returning to the wireless device 110, the controller 114 senses biometric information of the user 102 corresponding to the stored biometric information. The controller 114 then compares the stored biometric information to the biometric information sensed by the wireless device 110 to obtain a third comparison result. The controller 110 reauthenticates the user 102 in response to the third comparison result being less than the first threshold.

FIG. 1B illustrates another example system 100b for authenticating a user 102. System 100b is similar to system 100a previously described and illustrated with reference to FIG. 1A, except that system 100b excludes portable device 104. In this example, the controller 114 of the wireless device 110 retrieves stored biometric information of the user 102. In response to the user 102 approaching the wireless device 110, the controller 114 senses biometric information of the user 102 corresponding to the stored biometric information. In some examples, the controller senses the biometric information of the user 102 by sensing, via radio frequency (RF) sensing using radio transceiver 112, a vital sign of the user 102 corresponding to the stored biometric information. The controller 114 then compares the stored biometric information to the biometric information sensed using the radio transceiver 112 to obtain a first comparison result. The controller 114 authenticates the user 102 in response to the first comparison result being less than a first threshold as previously described with reference to FIG. 1A. Thus, in this example, if the biometric information of the user 102 is stored such that the stored biometric information may be accessed by the wireless device 110, the user 102 does not have to carry or wear a portable device 104 as illustrated in FIG. 1A.

FIG. 1C illustrates another example system 100c for authenticating a user 102. System 100c is similar to system 100a previously described and illustrated with reference to FIG. 1A, except that in system 100c the wireless device 110 further includes a biometric sensor 116. In some examples, the controller 114 senses the biometric information of the user 102 corresponding to biometric information sensed by the portable device 104 by sensing, via the biometric sensor 116 of the wireless device 110, the biometric information of the user 102 corresponding to the biometric information sensed by the biometric sensor 108 of the portable device 104. In other examples, the controller 114 senses the biometric information of the user 102 corresponding to stored biometric information of the user 102 by sensing, via the biometric sensor 116 of the wireless device 110, the biometric information of the user 102 corresponding to the stored biometric information.

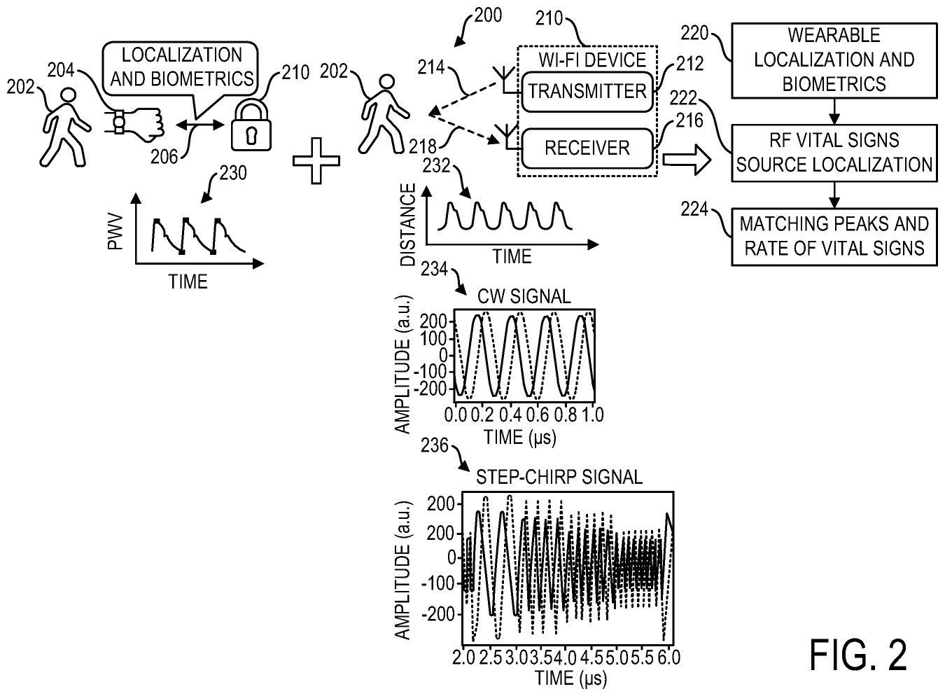

FIG. 2 illustrates another example system 200 for authenticating a user 202. System 200 includes a wearable device 204 (e.g., smart watch) worn by the user 202 and a wireless device 210 (e.g., smart lock). In some examples, wearable device 204 may be similar to portable device 104 and wireless device 210 may be similar to wireless device 110 as previously described and illustrated with reference to FIGS. 1A-1C. When the user 202 approaches the wireless device 210, the wearable device 204 transfers biometric information of the user 202 sensed by the wearable device 204 to the wireless device 210. In addition, a localization system of the wireless device 210 estimates the distance to the wearable device 204 (e.g., via AoA, phase ranging, ToF, etc.). Thus, as indicated at 206, localization and biometric information of wearable device 204 is obtained by the wireless device 210. For example, vital signs of the user 202 may be measured/sensed by the wearable device 204 and transferred to the wireless device 210, such as pulse wave velocity (PWV) of the user 202 versus time as indicated at 230.

In addition to the localization and biometrics from the wearable device 204, the wireless device 210 independently measures biometric information of the user 202 and estimates the distance to the user 202. Wireless device 210, which may be a Wi-Fi device, includes a transmitter 212 to generate signals incident on the user 202 as indicated at 214 and a receiver 216 to receive signals reflected by the user 202 as indicated at 218. The incident signals 214 and the reflected signals 218 may be used to estimate the distance to the user 202 as indicated by distance of the user 202 versus time as indicated at 232. The distance versus time as indicated at 232 may also be used to measure vital signs of the user, such as heart rate and/or respiration rate of the user 202.

In some examples, wireless device 210 includes a multiple-input multiple output (MIMO) Wi-Fi device in monostatic radar mode to sense biometric information of the user and distance to the user. The Wi-Fi sensing may be active and/or passive. Vital signs of the user 202 may also be sensed by measuring phase change in time. Some vital signs (e.g., respiratory information) may be extracted from channel state information (CSI) or from bistatic radar signals. RF sensed vital signs may be measured from the chest area of the user 202 by detecting motion and average (effective) dielectric permittivity changes of the body of the user caused by geometry changes. Different types of signals may be used for measurements such as a continuous wave (CW) signal as indicated for example at 234 (i.e., amplitude in a.u. versus time in microseconds), a frequency modulated continuous wave (FMCW) signal, a step-chirp signal as indicated for example at 236 (i.e., amplitude in a.u. versus time in microseconds), a pulse signal, an orthogonal frequency-division multiplexing (OFDM) signal, and/or a multifrequency signal. Localization of a vital sign source may be performed using an antenna array and/or wide band (WB) signals.

As indicated at 220, the wireless device 210 obtains wearable 204 localization and biometrics information. As indicated at 222, the wireless device 210 obtains RF vital signs source localization information. As indicated at 224, the wireless device 210 matches the peaks and the rate of the vital signs obtained by the wearable device 204 to the peaks and the rate of the vital signs obtained by the wireless device 210. If the peaks and the rate are within a first threshold, the wireless device 210 authenticates the user 202 and grants access to the user 202. If the peaks and the rate are not within the first threshold, the wireless device 210 does not authenticate the user 202 and denies access to the user 202. In some examples, the location of the wearable device 204 is compared to the location of the user 202. In this case, if the locations are within a second threshold and the peaks and the rate are within the first threshold, the wireless device 210 authenticates the user 202 and grants access to the user 202. If the locations are not within the second threshold or the peaks and the rate are not within the first threshold, the wireless device 210 does not authenticate the user 202 and denies access to the user 202.

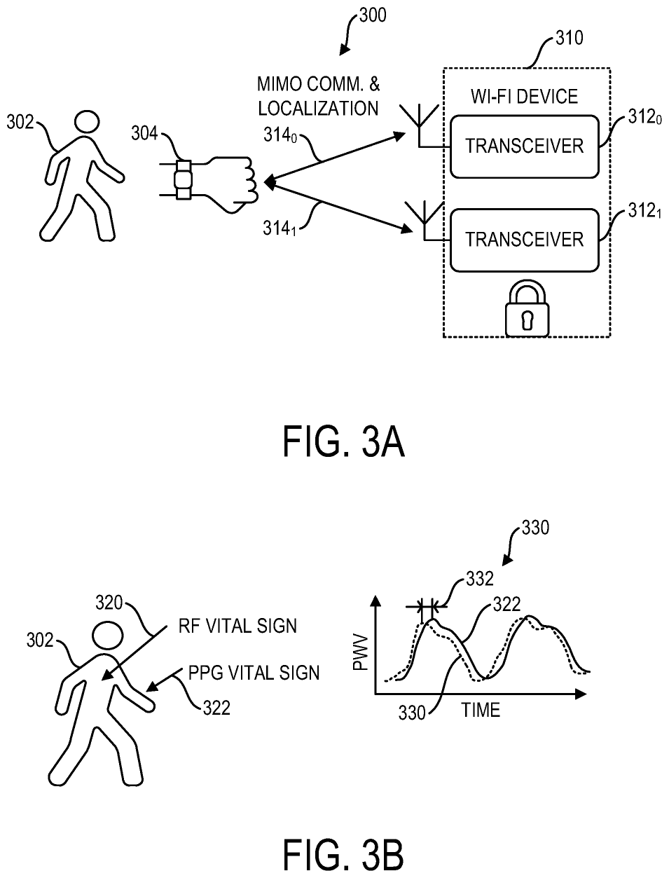

FIG. 3A illustrates another example system 300 for authenticating a user 302. System 300 includes a wearable device 304 (e.g., smart watch) worn by the user 302 and a wireless device 310 (e.g., secure device). The wireless device 310, which may be a MIMO Wi-Fi device, includes at least two transceivers 3120 and 3121. Each transceiver 3120 and 3121 may communicate with wearable device 304 as indicated by 3140 and 3141, respectively. Each transceiver 3120 and 3121 may also be used to generate signals incident on the user 302 and to receive signals reflected from the user 302. The wearable device 304 may measure vital signs (e.g., heart rate, respiration rate, temperature, etc.) of the user 304. A heart pulse waveform of the user 302 may be measured by Photoplethysmography (PPG), radar, or capacitive sensors that contain delay relative to heart contractions. In some examples, the delay may be ignored. A heart pulse waveform of the user 302 may also be measured by an electrocardiogram (ECG) like sensor or wearable sensors on the chest of the user 302 that do not require delay compensation. The wearable device 304 is localized (e.g., using ToF, AoA) by the wireless device 310. The wearable device 304 transmits biometric information measured by the wearable device 304 to the wireless device 310.

As shown in FIG. 3B as indicated at 322, a PPG of the user 302 may be sensed by the wearable device 304 while as indicated at 320 a RF vital sign of the user 302 may be sensed by the wireless device 310. As indicated by graph 330, the PWV 322 as sensed by the wearable device 304 is delayed relative to the PWV 320 sensed by the wireless device 310. The delay 332 due to the local measuring by the wearable device 304 and a pulse transit time (PTT) may be estimated and removed prior to comparing the signals for authenticating the user 302.

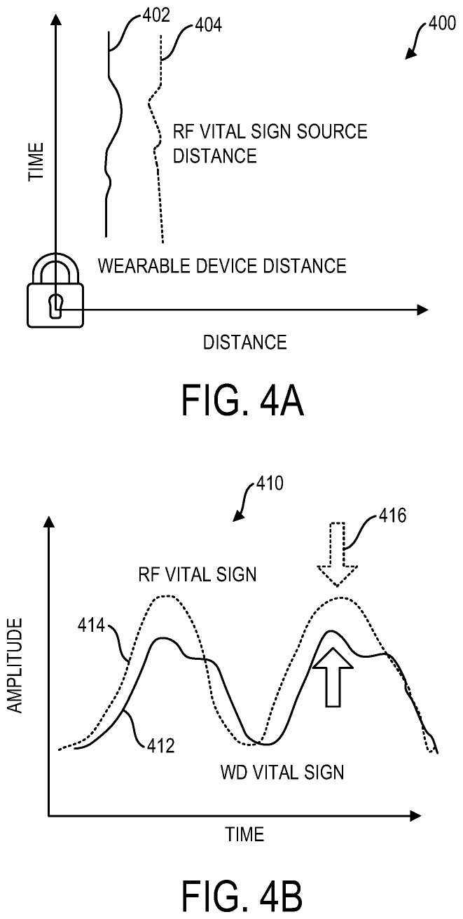

FIG. 4A is a graph 400 illustrating a distance criteria for authenticating a user. Graph 400 includes wearable device distance 402 (e.g., sensed by AoA, phase ranging, ToF, etc.) and RF vital sign source distance 404 (e.g., sensed by Wi-Fi sensing, radar, etc.) versus time. The distance to the wearable device 402 and to the human body (i.e., RF vital sign source) 404 should not exceed a threshold that is defined by body geometry (e.g., distance from wrist to chest). If the distance to the wearable device 402 and to the human body 404 is within the threshold, the user may be authenticated. If the distance to the wearable device 402 and to the human body 404 is not within the threshold, the user may not be authenticated.

FIG. 4B is a graph 410 illustrating a vital sign criteria for authenticating a user. Graph 410 includes a wearable device vital sign amplitude 412 (e.g., sensed by a biometric sensor) and a RF vital sign amplitude 414 (e.g., sensed by Wi-Fi sensing, radar, etc.) versus time. For example, the wearable device may sense the heart rate of the user, which may be compared to the heart rate of the user measured by RF sensing using wireless communication for localization (e.g., ToF). The distance between the peaks (or troughs) in the vital sign waveforms 412 and 414 provide additional information for authenticating the user. If the distance between the wearable device and the vital sign RF source is within a threshold as described above with reference to FIG. 4A, if the RF measured 414 and the wearable device measured 412 vital sign waveforms (e.g., heart rate) are within a threshold, and if the distance between peaks as indicated at 416 of vital signs measured by the wearable device and by RF sensing are within a threshold, the user is authenticated. If any of the thresholds are not met, the user is not authenticated.

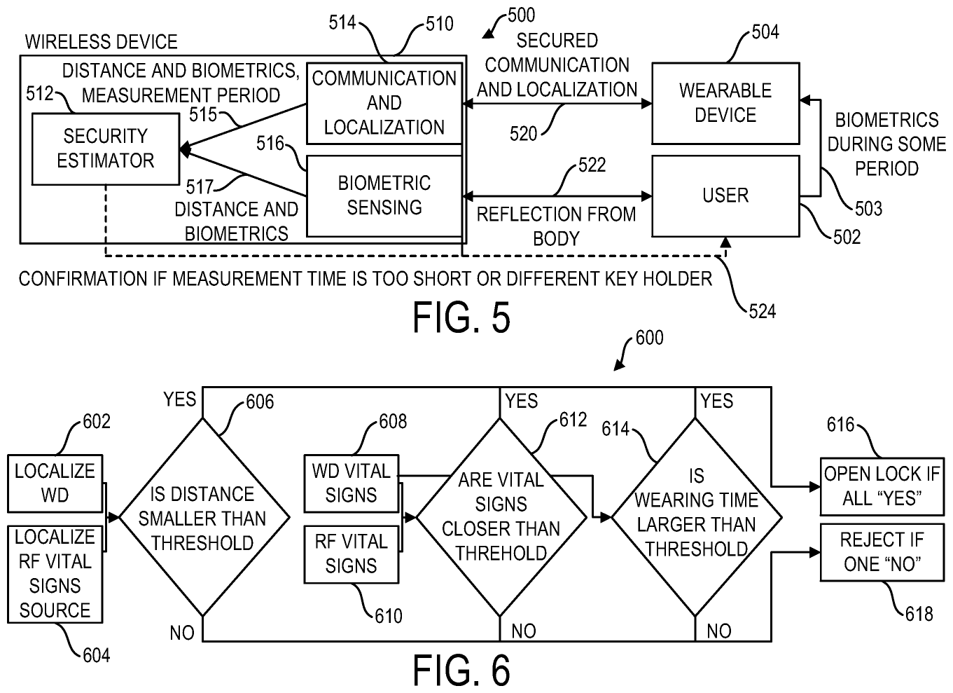

FIG. 5 illustrates another example system 500 for authenticating a user 502. System 500 includes a wireless device 510 (e.g., smart lock) and a wearable device 504 worn (e.g., on wrist) by the user 502. The wireless device 510 includes a security estimator 512, a communication and localization component 514, and a biometric sensing component 516. The wearable device 504 measures biometrics (e.g., vital signs, such as heart rate) of the user 502 during some period as indicated at 503. The wearable device 504 continues measurements during some time period (e.g., active time), which may be used as another authentication criteria.

The communication and localization component 514 performs secured communication and localization of the wearable device 504 as indicated at 520 and transmits the distance, biometrics, and measurement period (e.g., active time) to the security estimator 512 as indicated at 515. The biometric sensing component 516 uses RF sensing to sense biometrics of the user 502 using signals reflected from the user's body as indicated at 522 and transmits the distance and biometrics to the security estimator 512 as indicated at 517. The security estimator 512 compares the information from the communication and localization component 514 to the information from the biometric sensing component 516 to authenticate the user 502. Security estimator 512 may deny authentication of the user 502 or request confirmation from the user 502 as indicated at 524 if the measurement time is too short or a different key holder is detected (e.g., the user 502 is not wearing the wearable device 504).

Distance and biometrics allows recognition of the wearable device owner for access control. For example, if a wearable device owner is detected as being different from a vehicle driver, confirmation from the owner may be requested prior to authenticating the owner.

FIG. 6 illustrates one example method 600 for authenticating a user for a smart lock application. At 602, method 600 includes localizing a wearable device (WD) by measuring the location of the wearable device. At 604, method 600 includes localizing a RF vital signs source by measuring the location of a user (e.g., the chest of the user). At 606, method 600 includes comparing the location of the wearable device to the location of the RF vital signs source and determining whether the distance between the two locations is smaller than a first threshold. If the distance between the two locations is not smaller than the first threshold, the user is rejected as indicated at 618.

At 608, method 600 includes measuring vital signs using the wearable device (e.g., using a biometric sensor). At 610, method 600 includes measuring RF vital signs (e.g., using Wi-Fi sensing, radar, etc.). At 612, method 600 includes comparing the wearable device vital signs to the RF vital signs and determining whether the vital signs are closer than a second threshold (e.g., vital signs parameters and/or waveforms substantially match). If the vital signs are not closer than the second threshold, the user is rejected as indicated at 618.

At 614, method 600 includes determining whether the wearing time (e.g., active time) of the wearable device is larger than a third threshold. If the wearing time is not larger than the third threshold, the user is rejected as indicated at 618. If the distance between the two locations is smaller than the first threshold at 606, if the vital signs are closer than the second threshold at 612, and if the wearing time is larger than the third threshold at 614, then at 616 the smart lock is opened.

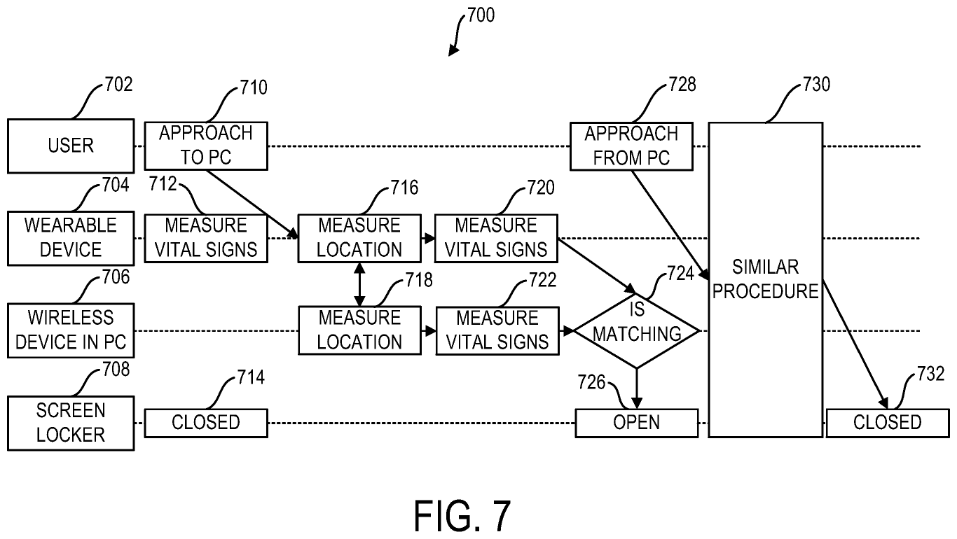

FIG. 7 illustrates one example method 700 for authenticating a user for a PC screen locker application. Method 700 may be implemented by a user 702, a wearable device 704, a wireless device in a PC 706, and a screen locker 708. As indicated at 712, the wearable device 704 measures vital signs of the user 702. As indicated at 714, the screen locker 708 is initially closed. As indicated at 710, the user 702 approaches the PC. In response to the user approaching the PC, the wearable device 704 location is measured at 716 and the user 702 location is measured by the wireless device 706 at 718. The wearable device 704 then measures vital signs of the user as indicated at 720 and the wireless device 706 measures vital signs of the user as indicated at 722.

At 724, the wireless device 706 determines whether the distance between the wearable device 704 and the wireless device 706 and the distance between the user 702 and the wireless device 706 substantially match, and whether the vital signs measured by the wearable device 704 substantially correlate to the vital signs measured by the wireless device 706. If both the distances and the vital signs substantially match, then at 726 the screen locker is opened, otherwise the screen locker remains closed. The procedure of steps 716-726 may be periodically repeated to provide additional security. If the user 702 moves away from the PC, the screen locker 708 closes. If the user 702 approaches the PC again as indicated at 728, as indicated at 730, a similar procedure as steps 716-726 is performed. When the user 702 moves away from the PC again, the screen locker is closed again as indicated at 732.

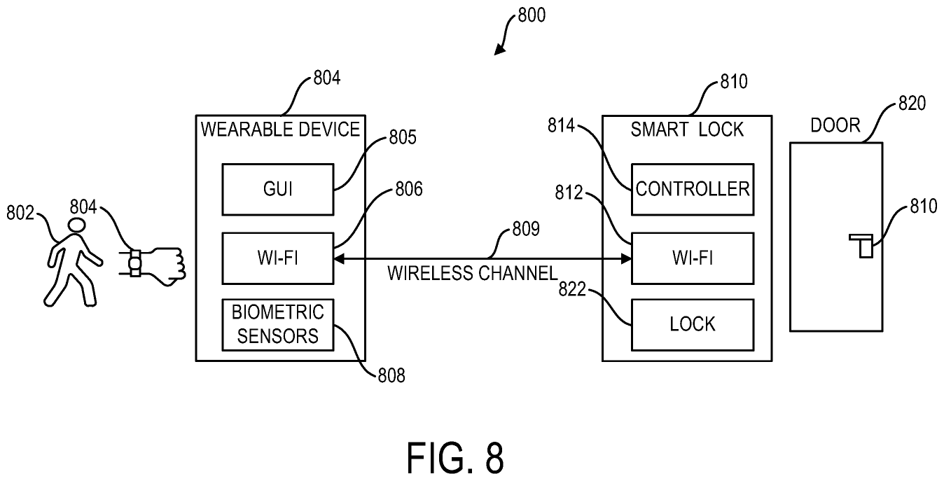

FIG. 8 illustrates one example system 800 for authenticating a user 802 for a smart lock application. System 800 includes a wearable device 804 (e.g., smart watch) and a door 820 including a smart lock 810. Wearable device 804 includes a graphical user interface (GUI) 805, a Wi-Fi transceiver 806, and biometric sensors 808. The biometric sensors 808 sense biometric information (e.g., vital signs) of the user 802. GUI 805 enables the user 802 to interact with the wearable device 804, such as to initiate a biometric measurement by the biometric sensors 808 and/or to initiate a transfer of biometric information from the wearable device 804 to the smart lock 810. Smart lock 810 includes a Wi-Fi transceiver 812, a controller 814, and an electromechanical lock 822. The Wi-Fi transceiver 806 of the wearable device 804 communicates with the Wi-Fi transceiver 812 of the smart lock 810 over a wireless channel 809. In other examples, BLE transceivers may be used in place of or in addition to Wi-Fi transceiver 806 and/or Wi-Fi transceiver 812. In some examples, a 2×2 Wi-Fi transceiver may be used for Wi-Fi transceiver 812 and may act as a radar for smart lock 810 for localization of the user 802 and the measurement of vital signs of the user 802. In some examples, a radar (e.g., 60 GHz) may be used in place of or in addition to the Wi-Fi transceiver 812 for localization of the user 802 and/or the measurement of vital signs of the user 802.

Controller 814 controls the operation of smart lock 810. In response to the localization of the wearable device 804 and the biometric information sensed by the wearable device 804 substantially matching the localization of the user 802 and the biometric information of the user 802 measured by the smart lock 810, controller 814 unlocks the lock 822 to grant the user access through the door 820. In response to the localization of the wearable device 804 and the biometric information sensed by the wearable device 804 not substantially matching the localization of the user 802 and the biometric information of the user 802 measured by the smart lock 810, controller 814 keeps the lock 822 locked to deny the user access through the door 820.

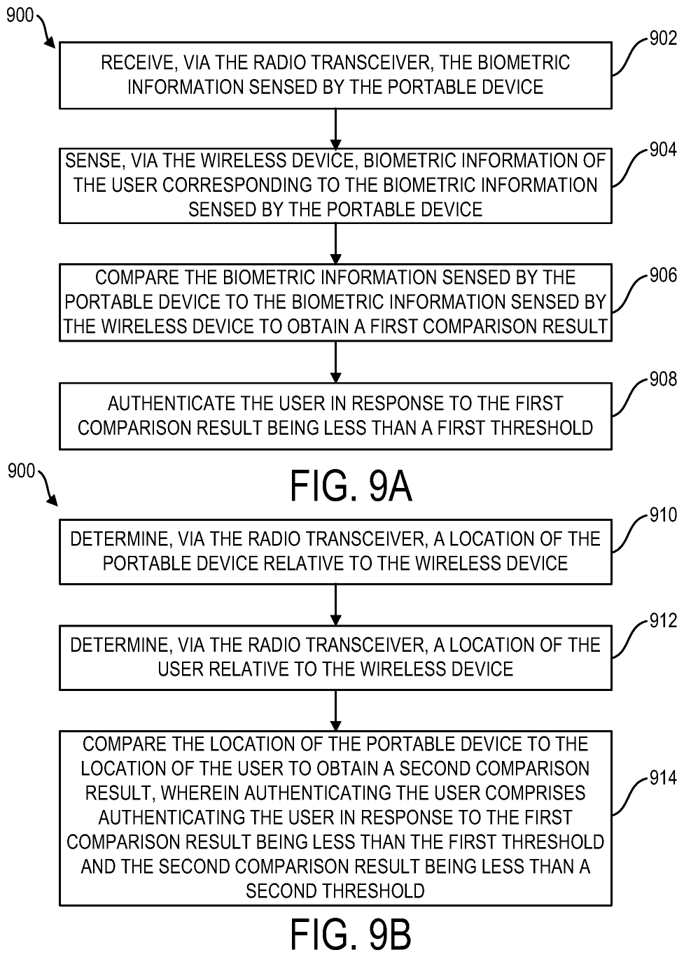

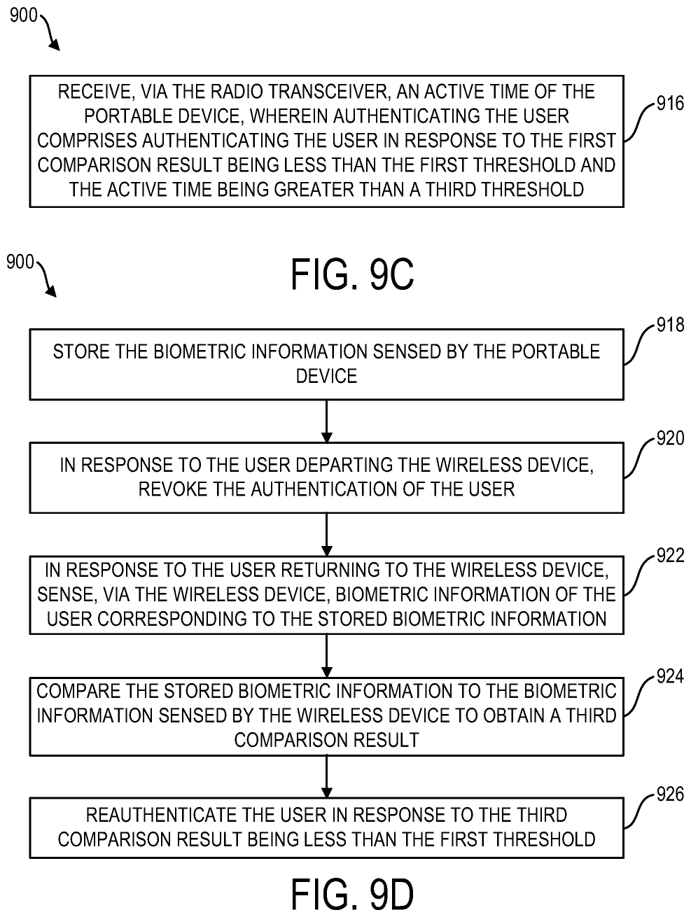

FIGS. 9A-9D are flow diagrams illustrating one example method 900 for authenticating a user (e.g., 102 of FIGS. 1A-1C). Method 900 may be implemented by a system (e.g., 100a, 100c) including a portable device (e.g., 104) to sense biometric information (e.g., via biometric sensor 108) of a user and a wireless device (e.g., 110) including a controller (e.g., 114) and a radio transceiver (e.g., 112). As illustrated in FIG. 9A at 902, the controller is configured to receive, via the radio transceiver, the biometric information sensed by the portable device. In some examples, the controller is configured to receive the biometric information sensed by the portable device in response to the user initiating a transfer of the biometric information sensed by the portable device to the wireless device (e.g., via GUI 805 of FIG. 8). In other examples, the controller is configured to receive the biometric information sensed by the portable device automatically in response to the user approaching the wireless device (e.g., as indicated at 710 of FIG. 7).

At 904, the controller is configured to sense, via the wireless device, biometric information of the user corresponding to the biometric information sensed by the portable device. In some examples, the portable device includes a vital sign sensor and the biometric information sensed by the portable device includes a vital sign of the user, and the controller is configured to sense the biometric information of the user corresponding to the biometric information sensed by the portable device by sensing, via radio frequency (RF) sensing (e.g., via radio transceiver 112), a vital sign of the user corresponding to the vital sign sensed by the vital sign sensor of the portable device. In some examples, the portable device includes a first biometric sensor (e.g., 108) to sense the biometric information of the user, the wireless device includes a second biometric sensor (e.g., 116), and the controller is configured to sense the biometric information of the user corresponding to the biometric information sensed by the portable device by sensing, via the second biometric sensor, the biometric information of the user corresponding to the biometric information sensed by the first biometric sensor. At 906, the controller is configured to compare the biometric information sensed by the portable device to the biometric information sensed by the wireless device to obtain a first comparison result. At 908, the controller is configured to authenticate the user in response to the first comparison result being less than a first threshold.

As illustrated in FIG. 9B at 910, the controller may be further configured to determine, via the radio transceiver, a location of the portable device relative to the wireless device. At 912, the controller may be further configured to determine, via the radio transceiver, a location of the user relative to the wireless device. At 914, the controller may be further configured to compare the location of the portable device to the location of the user to obtain a second comparison result, wherein authenticating the user comprises authenticating the user in response to the first comparison result being less than the first threshold and the second comparison result being less than a second threshold.

As illustrated in FIG. 9C at 916, the controller may further be configured to receive, via the radio transceiver, an active time of the portable device, wherein authenticating the user comprises authenticating the user in response to the first comparison result being less than the first threshold and the active time being greater than a third threshold.

At illustrated in FIG. 9D at 918, the controller may further be configured to store the biometric information sensed by the portable device. At 920, the controller may be further configured to in response to the user departing the wireless device, revoke the authentication of the user. At 922, the controller may be further configured to in response to the user returning to the wireless device, sense, via the wireless device, biometric information of the user corresponding to the stored biometric information. At 924, the controller may be further configured to compare the stored biometric information to the biometric information sensed by the wireless device to obtain a third comparison result. At 926, the controller may be further configured to reauthenticate the user in response to the third comparison result being less than the first threshold.

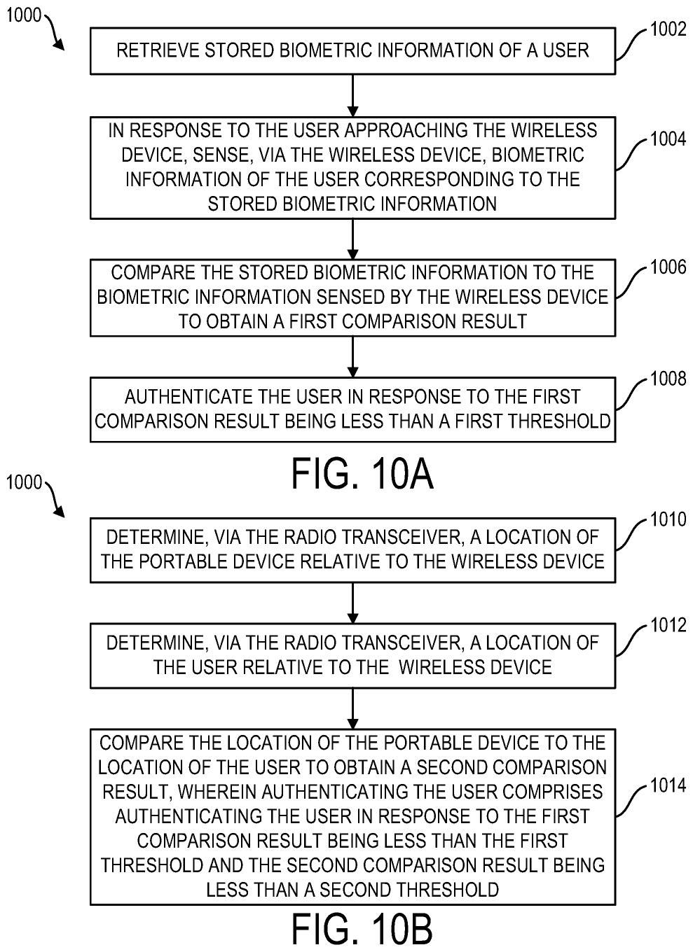

FIGS. 10A and 10B are flow diagrams illustrating another example method 1000 for authenticating a user. Method 1000 may be implemented by a system (e.g., 100a, 100b, 100c) including a wireless device (e.g., 110) including a controller (e.g., 114) and a radio transceiver (e.g., 112). In some examples, the system may further include a portable device (e.g., 104) configured to be carried or worn by the user. As illustrated in FIG. 10A at 1002, the controller is configured to retrieve stored biometric information of a user. At 1004, the controller is configured to in response to the user approaching the wireless device, sense, via the wireless device, biometric information of the user corresponding to the stored biometric information. In some examples, the controller is configured to sense the biometric information of the user corresponding to the stored biometric information by sensing, via radio frequency (RF) sensing (e.g., via radio transceiver 112), a vital sign of the user corresponding to the stored biometric information. In other examples, the wireless device includes a biometric sensor (e.g., 116), and the controller is configured to sense the biometric information of the user corresponding to the stored biometric information by sensing, via the biometric sensor, the biometric information of the user corresponding to the stored biometric information. At 1006, the controller is configured to compare the stored biometric information to the biometric information sensed by the wireless device to obtain a first comparison result. At 1008, the controller is configured to authenticate the user in response to the first comparison result being less than a first threshold.

As illustrated in FIG. 10B at 1010, the controller may be further configured to determine, via the radio transceiver, a location of the portable device relative to the wireless device. At 1012, the controller may be further configured to determine, via the radio transceiver, a location of the user relative to the wireless device. In some examples, the controller may be further configured to determine the location of the user relative to the wireless device by determining, via radio frequency (RF) sensing (e.g., via radio transceiver 112), the location of the user relative to the wireless device. At 1014, the controller may be further configured to compare the location of the portable device to the location of the user to obtain a second comparison result, wherein authenticating the user comprises authenticating the user in response to the first comparison result being less than the first threshold and the second comparison result being less than a second threshold.

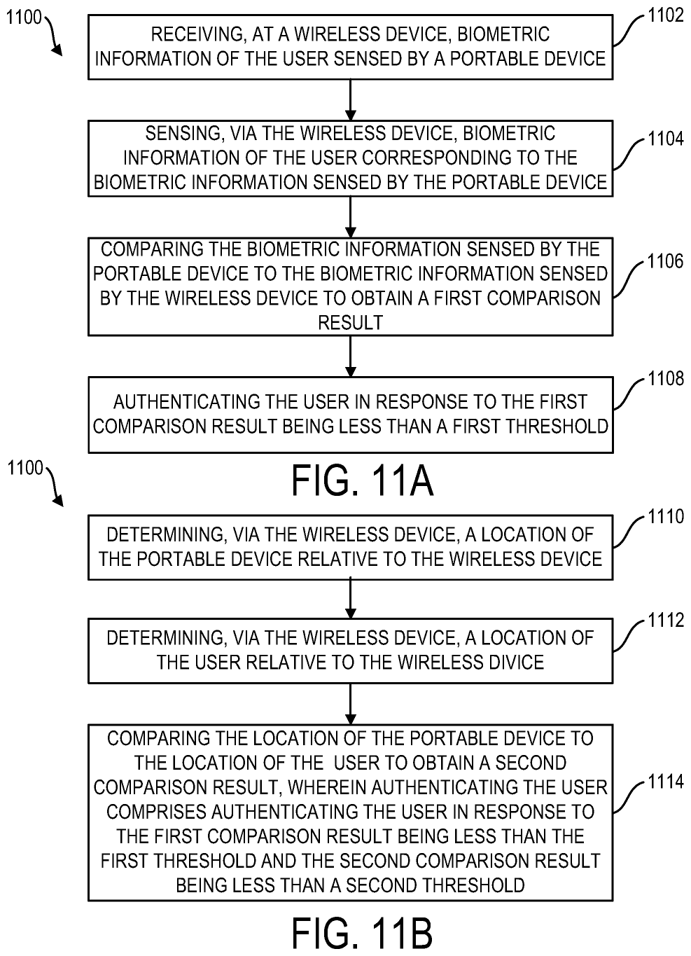

FIGS. 11A and 11B are flow diagrams illustrating another example method 1100 for authenticating a user (e.g., 102). As illustrated in FIG. 11A at 1102, method 1100 includes receiving, at a wireless device (e.g., 110), biometric information of the user sensed by a portable device (e.g., 104). At 1104, method 1100 includes sensing, via the wireless device, biometric information of the user corresponding to the biometric information sensed by the portable device. In some examples, sensing the biometric information of the user corresponding to the biometric information sensed by the portable device comprises sensing the biometric information of the user corresponding to the biometric information sensed by the portable device via radio frequency (RF) sensing (e.g., via radio transceiver 112). In other examples, sensing the biometric information of the user corresponding to the biometric information sensed by the portable device comprises sensing the biometric information of the user corresponding to the biometric information sensed by the portable device via a biometric sensor (e.g., 116). At 1106, method 1100 includes comparing the biometric information sensed by the portable device to the biometric information sensed by the wireless device to obtain a first comparison result. At 1108, method 1100 includes authenticating the user in response to the first comparison result being less than a first threshold.

As illustrated in FIG. 11B at 1110, method 1100 may further include determining, via the wireless device, a location of the portable device relative to the wireless device. At 1112, method 1100 may further include determining, via the wireless device, a location of the user relative to the wireless device. At 1114, method 1100 may further include comparing the location of the portable device to the location of the user to obtain a second comparison result, wherein authenticating the user comprises authenticating the user in response to the first comparison result being less than the first threshold and the second comparison result being less than a second threshold.

It is to be understood that the features of the various exemplary embodiments described herein may be combined with each other, unless specifically noted otherwise.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A system comprising:
a portable device to sense biometric information of a user; and
a wireless device comprising a controller and a radio transceiver,
wherein the controller is configured to:
receive, via the radio transceiver, the biometric information sensed by the portable device;
sense, via the wireless device, biometric information of the user corresponding to the biometric information sensed by the portable device;
compare the biometric information sensed by the portable device to the biometric information sensed by the wireless device to obtain a first comparison result; and
authenticate the user in response to the first comparison result being less than a first threshold.

2. The system of claim 1, wherein the controller is configured to:
determine, via the radio transceiver, a location of the portable device relative to the wireless device;
determine, via the radio transceiver, a location of the user relative to the wireless device; and
compare the location of the portable device to the location of the user to obtain a second comparison result,
wherein authenticating the user comprises authenticating the user in response to the first comparison result being less than the first threshold and the second comparison result being less than a second threshold.

3. The system of claim 1, wherein the controller is configured to:
receive, via the radio transceiver, an active time of the portable device,
wherein authenticating the user comprises authenticating the user in response to the first comparison result being less than the first threshold and the active time being greater than a third threshold.

4. The system of claim 1, wherein the controller is configured to receive the biometric information sensed by the portable device in response to the user initiating a transfer of the biometric information sensed by the portable device to the wireless device.

5. The system of claim 1, wherein the controller is configured to receive the biometric information sensed by the portable device automatically in response to the user approaching the wireless device.

6. The system of claim 1, wherein the controller is configured to store the biometric information sensed by the portable device such that subsequent to authenticating the user the controller is further configured to:
in response to the user departing the wireless device, revoke the authentication of the user;
in response to the user returning to the wireless device, sense, via the wireless device, biometric information of the user corresponding to the stored biometric information;
compare the stored biometric information to the biometric information sensed by the wireless device to obtain a third comparison result; and
reauthenticate the user in response to the third comparison result being less than the first threshold.

7. The system of claim 1, wherein the portable device comprises a vital sign sensor and the biometric information sensed by the portable device comprises a vital sign of the user, and
wherein the controller is configured to sense the biometric information of the user corresponding to the biometric information sensed by the portable device by sensing, via radio frequency (RF) sensing, a vital sign of the user corresponding to the vital sign sensed by the vital sign sensor of the portable device.

8. The system of claim 1, wherein the portable device comprises a first biometric sensor to sense the biometric information of the user,
wherein the wireless device comprises a second biometric sensor, and
wherein the controller is configured to sense the biometric information of the user corresponding to the biometric information sensed by the portable device by sensing, via the second biometric sensor, the biometric information of the user corresponding to the biometric information sensed by the first biometric sensor.

9. The system of claim 1, wherein the biometric information of the user comprises at least one of respiration rate information, pulse rate information, heart rate information, electrocardiogram information, fingerprint information, or iris information.

10. The system of claim 1, wherein the portable device comprises a wearable device.

11. The system of claim 1, wherein the wireless device comprises at least one of a smart lock, a vehicle, or a computing device.

12. A system comprising:
a wireless device comprising a controller and a radio transceiver,
wherein the controller is configured to:
retrieve stored biometric information of a user;
in response to the user approaching the wireless device, sense, via the wireless device, biometric information of the user corresponding to the stored biometric information;
compare the stored biometric information to the biometric information sensed by the wireless device to obtain a first comparison result; and
authenticate the user in response to the first comparison result being less than a first threshold.

13. The system of claim 12, further comprising:
a portable device configured to be carried or worn by the user,
wherein the controller is configured to:
determine, via the radio transceiver, a location of the portable device relative to the wireless device;
determine, via the radio transceiver, a location of the user relative to the wireless device; and
compare the location of the portable device to the location of the user to obtain a second comparison result,
wherein authenticating the user comprises authenticating the user in response to the first comparison result being less than the first threshold and the second comparison result being less than a second threshold.

14. The system of claim 13, wherein the controller is configured to determine the location of the user relative to the wireless device by determining, via radio frequency (RF) sensing, the location of the user relative to the wireless device.

15. The system of claim 12, wherein the controller is configured to sense the biometric information of the user corresponding to the stored biometric information by sensing, via radio frequency (RF) sensing, a vital sign of the user corresponding to the stored biometric information.

16. The system of claim 12, wherein the wireless device comprises a biometric sensor, and
wherein the controller is configured to sense the biometric information of the user corresponding to the stored biometric information by sensing, via the biometric sensor, the biometric information of the user corresponding to the stored biometric information.

17. A method for authenticating a user, the method comprising:
receiving, at a wireless device, biometric information of the user sensed by a portable device;
sensing, via the wireless device, biometric information of the user corresponding to the biometric information sensed by the portable device;
comparing the biometric information sensed by the portable device to the biometric information sensed by the wireless device to obtain a first comparison result; and
authenticating the user in response to the first comparison result being less than a first threshold.

18. The method of claim 17, further comprising:
determining, via the wireless device, a location of the portable device relative to the wireless device;
determining, via the wireless device, a location of the user relative to the wireless device; and
comparing the location of the portable device to the location of the user to obtain a second comparison result,
wherein authenticating the user comprises authenticating the user in response to the first comparison result being less than the first threshold and the second comparison result being less than a second threshold.

19. The method of claim 17, wherein sensing the biometric information of the user corresponding to the biometric information sensed by the portable device comprises sensing the biometric information of the user corresponding to the biometric information sensed by the portable device via radio frequency (RF) sensing.

20. The method of claim 17, wherein sensing the biometric information of the user corresponding to the biometric information sensed by the portable device comprises sensing the biometric information of the user corresponding to the biometric information sensed by the portable device via a biometric sensor.
